(19) United States
(12) Patent Application Publication
(10) Pub. No.: US 2004/0109385 A1
(43) Pub. Date: Jun. 10, 2004

(54) Systems and methods for thawing, mixing, and processing biopharmaceutical materials

(75) Inventor: Richard Wisniewski, San Mateo, CA (US)

Correspondence Address: HESLIN ROTHENBERG FARLEY & MESITI PC, 5 COLUMBIA CIRCLE, ALBANY, NY, 12203, US

(73) Assignee: Integrated Biosystems, Inc., Napa, CA

(21) Appl. No.: 10/634,231

(22) Filed: Aug. 5, 2003

Related U.S. Application Data
(60) Provisional application No. 60/401,272, filed on Aug. 5, 2002.

(51) Int. Cl. B01F 9/00

(52) U.S. Cl. 366/208

(57) ABSTRACT

The present invention provides a system for thawing, mixing and processing a biopharmaceutical material, which includes a moveable platform and a container for holding the biopharmaceutical material. The container is operably mounted on the platform to allow the container to be skewed relative to the platform. Further, the container may be tilted relative to the platform.

### CROSS-REFERENCE TO RELATED APPLICATIONS

This application claims the benefit of U.S. Provisional Application Serial No. 60/401,272, filed Aug. 5, 2002, which is hereby incorporated by reference. This application relates to U.S. patent application Ser. No. 09/579,846, filed May 26, 2000, entitled Enhanced Thawing of Biopharmaceutical Solutions Using Oscillatory Motion, the entirety of which is incorporated herein by reference.

### TECHNICAL FIELD

This invention relates, in general, to biopharmaceutical material preservation methods and systems, and more particularly to a system and method for thawing, mixing, or processing biopharmaceutical materials.

### BACKGROUND ART

Preservation of biopharmaceutical materials, such as cryopreservation, is important in the manufacture, use, transport, storage and sale of such materials. For example, biopharmaceutical materials are often preserved by freezing between processing steps and during storage. Similarly, biopharmaceutical materials are often frozen and thawed as part of the development process to enhance the quality or to simplify the development process.

When utilizing cryopreservation, the overall quality, and in particular pharmaceutical activity, of the pharmaceutical materials is desirably preserved, without substantial degradation of the biopharmaceutical materials.

Currently, in some aspects, cryopreservation of biopharmaceutical materials involves placing a container comprising the biopharmaceutical materials in a cabinet or chest freezer and allowing the biopharmaceutical materials to freeze. In current cryopreservation techniques, a container enclosing biopharmaceutical materials is placed on a solid or wire-frame shelf in the cabinet or chest freezer. The biopharmaceutical materials are left to freeze until they are solid, in an uncontrolled fashion.

Similarly, thawing of such materials typically involved removing them from a freezer and allowing them to thaw at room temperature. Such uncontrolled thawing can also lead to product degradation or loss. Generally, rapid thawing of biopharmaceutical materials results in less product loss than slower thawing. Further, it may also be desirable to control temperature of the biopharmaceutical materials during a thawing process since exposure of some biopharmaceutical materials to elevated temperatures may also lead to product loss. For example, it may be desirable to maintain a thawing biopharmaceutical material at about 0° C. when still in liquid and solid form during thawing thereof.

Further, it may be desirable to mix liquid biopharmaceutical material at a homogeneous temperature above, below, or at an ambient temperature level. The mixing of biopharmaceutical materials in containers is important in the manufacture, use, transport, and storage of such materials. For example, biopharmaceutical materials are often blended, compounded, or formulated by mixing during processing steps and kept homogeneous during storage. Similarly, biopharmaceutical materials are often processed, e.g., blended, compounded, dissolved, or formulated by mixing with temperature control as part of this development process to enhance the quality or to simplify the development process.

Currently, in some aspects, mixing of biopharmaceutical materials involves transferring the product out of a container comprising the biopharmaceutical materials into a tank with mechanical agitator, mixing and transferring the material back to the container. During those operations the containment may be broken and the product sterility and purity compromised. The homogeneous product may separate again after transfer back to its original container. Multiple transfer may expose product to excessive shear and to gas-liquid interfaces which may adversely affect the product. Thus, it is preferable if such mixing can be accomplished without transferring the biopharmaceutical material out of the container or inserting a mixer into the container, i.e., noninvasive mixing is preferred. When utilizing such noninvasive mixing, the overall quality, sterility, and in particular pharmaceutical activity, of the biopharmaceutical materials is desirably preserved, without substantial degradation of the biopharmaceutical materials.

Thus, there is a need for systems and methods for thawing and mixing biopharmaceutical materials that are controlled, do not result in loss of biopharmaceutical material, and are repeatable.

### SUMMARY OF THE INVENTION

The present invention provides, in a first aspect, a system for thawing, mixing, or processing of a biopharmaceutical material having a moveable platform and a container for holding the biopharmaceutical material. The container is operably mounted on the platform to allow the container to be skewed relative to the platform.

The present invention provides, in a second aspect, a system for thawing, mixing or processing of a biopharmaceutical material having a moveable platform and a container for holding the biopharmaceutical material. The container is operably mounted on the platform and the container is tiltable relative to the platform.

The present invention provides, in a third aspect, a method for thawing, mixing, or processing of biopharmaceutical materials which includes moving a container holding the biopharmaceutical materials in a first direction and skewing the container relative to the first direction.

The present invention provides, in a fourth aspect, a method for thawing, mixing, or processing biopharmaceutical materials which includes moving a container holding the biopharmaceutical materials and tilting a first end of the container relative to a second end of the container.

The present invention provides, in a fifth aspect, a system for thawing, mixing, or processing biopharmaceutical materials having a moveable platform, a container for holding the biopharmaceutical material, and means for positioning the container relative to the moveable platform in three dimensions.

The present invention provides, in a sixth aspect, a system for thawing, mixing or processing biopharmaceutical materials which includes a movable container which is skewable and tiltable relative to a direction of motion of the container.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention will be readily understood from the following detailed description of preferred embodiments taken in conjunction with the accompanying drawings in which:

FIG. 1 is a perspective view of a system for thawing or mixing biopharmaceutical materials, in accordance with the present invention;

FIG. 2 is a side view of the system of FIG. 1 having the container tilted in a first direction relative to the platform, in accordance with the present invention;

FIG. 3 is an end view of the system of FIG. 1 having the container tilted in a second direction relative to the platform, in accordance with the present invention;

FIG. 4 is a top view of the system of FIG. 1 having the container skewed relative to a platform;

FIG. 5 is a top view of the system of FIG. 1, showing a plurality of positions of the container relative to the platform;

FIG. 6 is a side view of the system of FIG. 1 with the container tilted and skewed relative to the platform;

FIG. 7 is an end view of the system of FIG. 6;

FIG. 8 is a top view of the system of FIG. 6; and

FIG. 9 is a perspective view of the system of FIG. 6.

### DETAILED DESCRIPTION OF ONE PREFERRED EMBODIMENT OF THE INVENTION

In accordance with the principles of the present invention, systems and methods for thawing or mixing biopharmaceutical materials are provided.

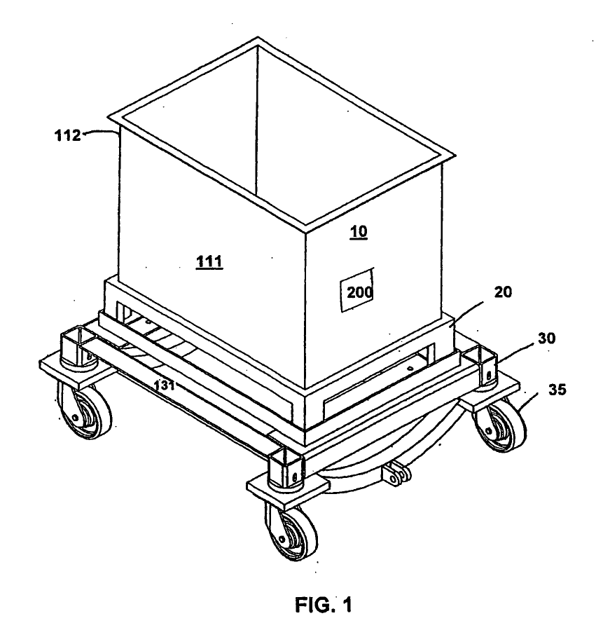

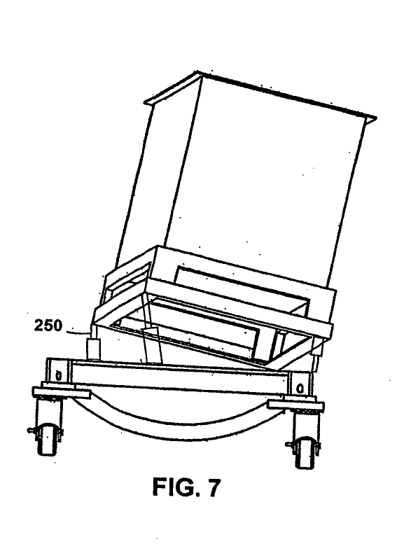

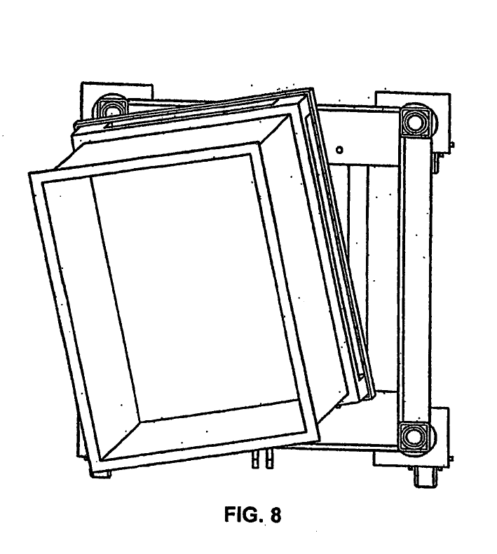

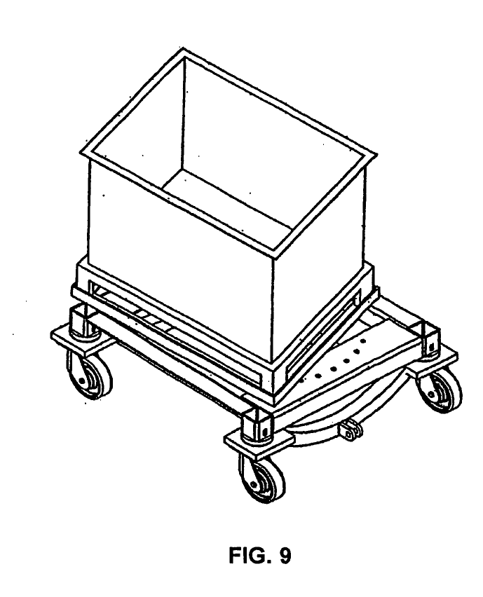

In an exemplary embodiment depicted in FIGS. 1-9, portions of a system for thawing, mixing, or processing biopharmaceutical materials are shown. This system may include a sterile container 10 attached to a base 20 which may be attached to a movable platform 30.

Container 10 may be adapted to receive and contain frozen and/or liquid biopharmaceutical materials. Sterile container 10 contains biopharmaceutical materials. In an embodiment, the biopharmaceutical materials may comprise protein solutions, protein formulations, amino acid solutions, amino acid formulations, peptide solutions, peptide formulations, DNA solutions, DNA formulations, RNA solutions, RNA formulations, nucleic acid solutions, nucleic acid formulations, antibodies and their fragments, enzymes and their fragments, vaccines, viruses and their fragments, biological cell suspensions, biological cell fragment suspensions (including cell organelles, nuclei, inclusion bodies, membrane proteins, and/or membranes), tissue fragments suspensions, cell aggregates suspensions, biological tissues in solution, organs in solution, embryos in solution, cell growth media, serum, biologicals, blood products, preservation solutions, fermentation broths, and cell culture fluids with and without cells, mixtures of the above and biocatalysts and their fragments. Other examples of biopharmaceutical materials include active pharmaceutical ingredients, inert bulking ingredients, buffering ingredients, solvents, emulsions, suspensions, micelles, vesicles, multiphase mixtures (for example, solid-liquid, or solid-liquid-liquid).

Movable platform 30 includes wheels 35 allowing it to be pulled or pushed along a guide or track 40 in a direction 45 by a pulling or driving mechanism 50. This movement may include oscillation, e.g., reversing movement, of platform 30 along a surface. For example, platform 30 may move from a first position, travel along track 40 to a second position, and it may then reverse course to return to the first position. The distance between these positions defines a terminal distance and movement between such positions defines such a reversing movement. Track 40 may be configured to maintain wheels 35 therebetween. Other examples of such movement include movement with varying acceleration, reversing movement with stops at each terminal distance, and movement with superimposed vibrations. Also, track 40 may be, for example, U-shaped, V-shaped, L-shaped, or inverted V-shaped to keep platform 30 moving in a fixed direction and/or a fixed route having a straight or curved path. In an unillustrated example, moveable platform 30 could include rollers, slides, or other motion-permitting supports instead of wheels 35 to allow movement thereof.

Such movement of container 10 via the movement of platform 30 promotes thawing and mixing of biopharmaceutical materials held in container 10. Such mixing could be performed for the purpose of processing and could be combined therewith, such as: dissolution, homogenization, chemical/biochemical reactions, formulations, or compounding. For example, the force imposed by a back side 112 of container 10 due to movement thereof may cause turbulence of portions or the whole volume of the biopharmaceutical material held in container 10. Such turbulence may promote thawing, mixing and processing of the biopharmaceutical materials. More particularly, thawing rates of biopharmaceutical materials may be accelerated by generation of movement of partially-thawed solid-liquid mixture comprising a biopharmaceutical solution against surfaces in a container, which may include heat transfer surfaces, such as heated and/or cooled walls and bottom of container 10 and/or portions of base 20. This movement may be generated wherein a liquid is moving against the surfaces and a solid in the liquid is moving against the liquid and against the surfaces. The patterns of liquid and solid movement may or may not be similar (the floating solid mass dynamics inside the vessel may or may not be similar to the liquid mass dynamics). Further, the relative movement of solid and liquid phases can enhance the thawing rate. Therefore, movement parameters, such as the terminal distance and frequency (e.g., motion timing to travel such terminal distance) may change after the solid part is completely thawed. For example, during thawing of the biopharmaceutical material, an oscillation (e.g., a reversing movement) rate of platform 30 and container 10 may comprise 45 reversing movements per minute, while the rate may increase to 55 reversing movements per minute when the biopharmaceutical material has thawed and mixing without thawing is occurring. Such rates may be determined based on various factors, including liquid level, time and/or distance of movement and geometry of the container being utilized.

The described dynamic movements of liquid and solid versus the container and its internal structures may turbulize the liquid phase, affect the boundary layer at the heat transfer surfaces, e.g., heated walls and bottom of the container, and at the melting solid surface, and mix the liquid. As a result, the heat transfer between the surfaces and liquid and solid phases of the biopharmaceutical solution is significantly enhanced. Increased heat transfer rate leads to very rapid thawing which may reduce or eliminate product degradation present in conventional, slow thawing, processes.

The heat transfer surfaces described above may be simply surfaces allowing heat transfer therethrough or they may include a temperature control element 200 (FIG. 1) which may be an electrical heater or a panel jacket attachable to the walls or bottom of container 10. Further, the element could provide infrared or microwave radiation. In another example, the walls and/or bottom of container 10 or base 20 could include heat exchangers which circulate heat transfer fluids therethrough, such as water, oil, glycol, silicone fluid, hot air or other heat transfer fluids as is known by those skilled in the art. The walls of container 10 could further include heat transfer enhancing structures such as fins and pins due to required high heat flux for product thawing, as will be understood by those skilled in the art.

Also, the mixing described above depends on container shape, liquid depth, and motion parameters (e.g., frequency, amplitude). Further, such mixing is noninvasive since it is not necessary to insert an agitator or other mixer therein to facilitate such mixing. Instead, the mixing is caused by the forces imposed on the biopharmaceutical material in container 10 due to the motion of platform 30 which thereby causes turbulence of the biopharmaceutical materials. The noninvasive nature of this mixing inhibits contamination of biopharmaceutical materials held in such containers since no mixing mechanism needs to be inserted therein and thus the contents of container 10 may be mixed without said being opened. Sterility of the biopharmaceutical material may thus be maintained. Further, environmental contamination due to biohazardous materials, for example, held in container 10 may be inhibited since there is no need to open container 10 to insert a mixing mechanism therein which could contaminate an ambient environment with the contents of container 10.

Further, as described above, oscillation of platform 30 may be utilized to promote thawing and mixing of biopharmaceutical material held in container 10. Such oscillatory motion may be harmonic or disharmonic. Further, such motion may be “micromotion” (i.e., small amplitude and high frequency) or “macromotion” (i.e., large amplitude and low frequency), as described in co-owned U.S. patent application Ser. No. 09/579,846, which is hereby incorporated herein by reference. Further, a combination of “micromotion” and “macromotion” could be utilized. Such motion may accelerate thawing as compared to motionless thawing and enhance mixing, processing and product homogenization. The frequency of the oscillation or reversing motion of platform 30 along track 40 may preferably range from 0.001 Hz to 20 Hz when used for thawing. Such movement may also be superimposed with a higher frequency motion, such as a motion at 50 Hz, for example. Also, for mixing and other processing higher or lower frequencies may be used.

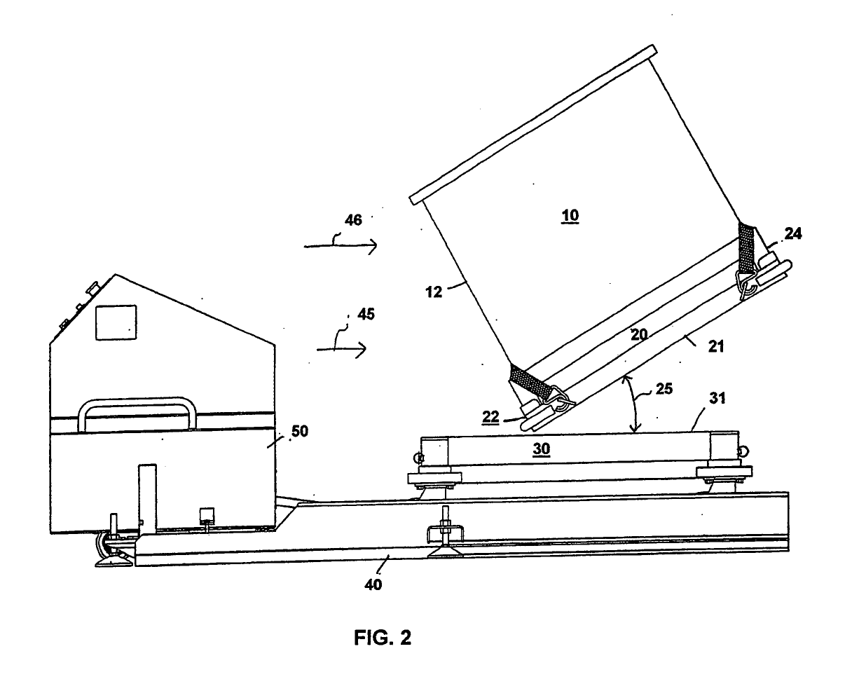

Container 10 attached to base 20 may be tilted relative to movable platform 30, as illustrated in FIGS. 2, 3, and 6-9. For example, a first end 22 of base 20 may be tilted relative to a second end 24 of base 20 and thus platform 30 such that an angle 25 therebetween may be up to about 45 degrees. Further, a third end 27 of base 20 may be tilted relative to a fourth end 28 of base 20 such that an angle 29 therebetween may be up to about 45 degrees. Such tilting also may cause turbulence in liquid portions or in the whole volume of the biopharmaceutical material held in container 10 during movement of platform 30 thus promoting thawing, mixing, or processing thereof. Further, such tilting may be performed by tilting-members 250 configured to raise and lower particular portions of base and/or container 10 relative to platform 30. For example, tilting-members 250 may be pistons, which are extendable and retractable to raise and lower, respectively, one or more portions of base 20 relative to platform 30.

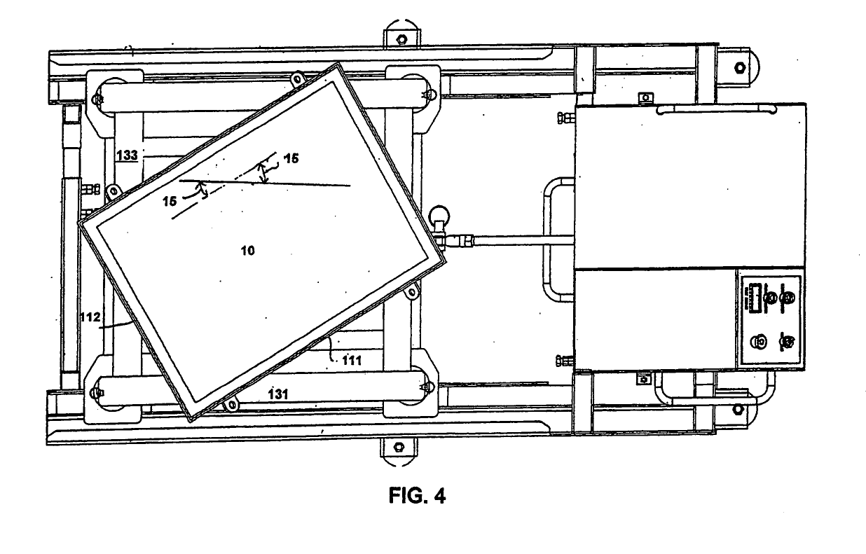

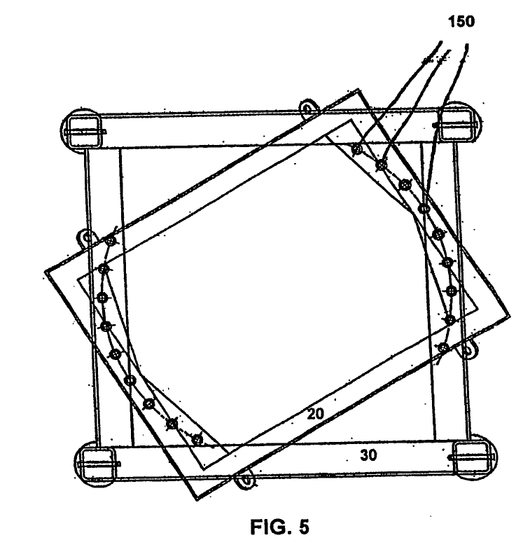

Container 10 attached to base 20 may also be skewed relative to platform 30. Specifically, base 20 may be rotated relative to platform 30 as depicted in FIGS. 4-9. Such rotation may be about an axis substantially perpendicular to direction 45, when base 20 is not tilted (i.e., bottom 21 of base 20 rests completely on platform 30). In one example, container 10 may be formed in a cubical shape and platform 30 may have rectangular sides arranged such that their sides may be positioned parallel to one another and parallel to sides of platform 30 in a first position. Specifically a first side 131 of platform 30 may be aligned with a first side 111 of container 10 and a second side 133 of platform 30 may be aligned with a second side 112 of container 10 in the first position as depicted in FIG. 1. Container 10 may be rotated to a second position, as depicted in FIG. 4 such that first side 131 is skewed relative to first side 111 and second side 133 is skewed relative to second side 112. For example, container 10 and base 20 might be rotated on platform 10 up to about 45 degrees relative to the first position. Also, base 20 may be rotated to an angle 15 which may be up to about 45 degrees relative to first direction 45 or an indicator line 46 substantially parallel to first direction 45. Also, platform 30 may include a pin (not shown) for holding base 20 in each of a plurality of skewing positions between 0 and about 45 degrees as depicted in FIG. 5. Base 20 may include a plurality of apertures 150 adapted to receive the pin of platform 30. Base 20 may also be moved (e.g., skewed) and releasably positioned relative to platform 30 utilizing one or more pistons (not shown) and/or clamping, locking, or other means (not shown) for releasably positioning base 20 relative to platform 30. As described above, turbulence caused by movement of platform 30 may promote thawing and mixing of biopharmaceutical materials held in container 20.

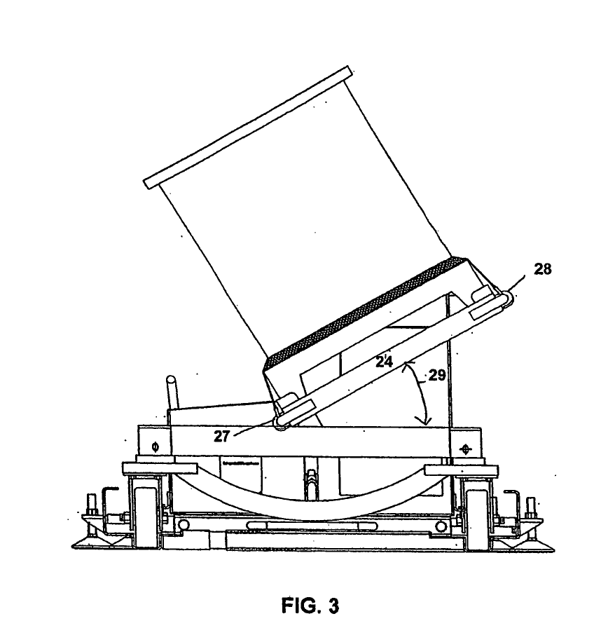

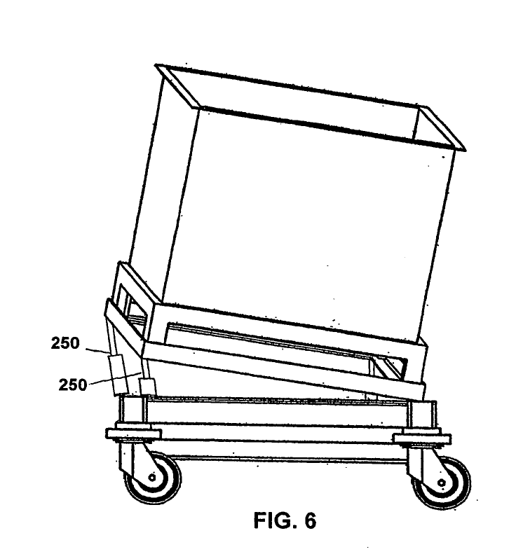

As will be understood by those skilled in the art, the skewing may be in the form of any type of rotating of base 20 and/or container 10 relative to platform 30 or the direction of motion which does not raise and/or lower base 20 relative to platform 30. Moreover, the tilting described may be performed with or without the skewing and vice versa. As depicted in FIGS. 6-9, base 20 may be tilted relative to platform 30 or a surface supporting the platform and also skewed. For example, base 20 may be tilted relative to platform 30 such that a top surface 31 of platform 30 may form a first side of a triangle, a bottom surface 21 of base 20 may form a hypotenuse, and a third side may be defined opposite angle 25, as depicted in FIG. 2. Base 20 may rotate about an axis substantially perpendicular to bottom surface 21 of base 20 to cause container 10 and base 20 to be skewed relative to platform 30, when base 20 is tilted relative to platform 30 at angle 25 as depicted in FIG. 2. Further, base 20 may be tilted relative to platform 30 such that top surface 31 forms a first side of a triangle, bottom surface 21 forms a hypotenuse, and a third side may be defined opposite angle 29, as depicted in FIG. 3. In such a case, base 20 may rotate about an axis substantially perpendicular to bottom surface 21 to cause container 10 in base 20 to be skewed relative to platform 30 and the direction of travel, when base 20 is tilted relative to platform 30 and angle 29. Moreover, as will be understood by one skilled in the art, base 20 and container 10 may be positioned in various three dimensional positions relative to platform 30.

The tilting and/or skewing described may be regulated for optimal thawing, mixing, or other processing conditions based on the speed and direction of travel of platform 30 in combination with the effect of such motion of liquid and solid biopharmaceutical materials held in container 10 in various states of skewing and/or tilting.

Further, the tilting and/or skewing described above may be performed manually or by a controller controlling a driver such as a motor to cause the tilting or skewing utilizing any number of mechanisms (e.g., tilting member 250), as will be understood by those skilled in the art. For example, hydraulic or pneumatic mechanisms may be utilized to regulate such tilting and/or skewing. Also, it will be evident to one skilled in the art that the movement of platform 30 may be caused by any number of mechanisms which may be manual or controlled by a controller. Various mechanisms for driving containers and containers useful in carrying out the present invention are disclosed in co-owned U.S. patent application Ser. No. 09/579,846 referenced above. For example, platform 30 could be moved mechanically, such as by an electric motor with a gear box and a cam with an arm. Other examples include providing motion to platform 30 via an electromagnetic solenoid, a spring loaded driver, return by a spring, a hydraulic drive, a pneumatic drive, or a magnetic driver. Further, platform 30 may travel along any number of paths, including a curved route, a circular route or an elliptical route, as also is described in the referenced patent application.

Moreover, container 10 may be formed in cubical, spherical, prismatic rectangular, prismatic rhomboidal, prismatic trapezoidal, prismatic polygon, straight cylindrical, tilted cylindrical, oval cylindrical, or any number of other shape. Further examples of container shapes include pyramidal (symmetrical or asymmetrical), toroidal (symmetrical or asymmetrical), annulus (symmetrical or asymmetrical), or elongated with a narrow ‘waist’ in a middle. Container 10 may also be tilted and/or skewed in various positions. Further, container 10 may be formed such that the skewing and/or tilting of container 10 relative to platform 30 and/or base 20 is done during manufacture thereof. More specifically, container 10, base 20, and platform 30 may be formed integral to each other such that skewing, tilting, and/or other three-dimensional positioning relative to each other is done during the manufacturing process, as opposed to by mechanical or other means subsequent to manufacture. The container may also be of a platform-less design (i.e., lacking a distinct platform and base) with supporting movement-permitting devices (e.g., wheels) directly attached to the container. Further, a container may be tilted or skewed relative to a plane of motion of the container instead of relative to a base or platform.

Container 10 may also include various internal features to aid in mixing of the contents thereof. For example, container 10 may also include corrugations, weirs, sloped bottoms, tilted walls, and/or baffles to facilitate mixing of the biopharmaceutical material. In one example, container 10 could include indentations or ribs which may promote mixing of the contents thereof during movement of container 10. Other examples include walls with impressed weirs, side baffles facing toward the interior of the container, mounds impressed in the sides of the containers, and a sloped bottom of the container. Also, any other devices and/or means for liquid turbulization, when platform 30 and container 10 are in motion, could be utilized such as grids, grates, screens, paddles, bars, beams, and blades.

Container 10 could also include a dome to promote mixing of the biopharmaceutical material. Such a dome comprising the top of container 10 may be configured to deflect moving liquid when it reaches the side walls of container 10 and rises during movement of container 10. Such deflection of liquid may direct it toward the container's center from its sides. The top of container 10 could also include a pyramidal roof having transition edges between the vertical walls and the walls of the pyramidal top which may be rounded with a radius of between 1/16 inch and 10 inches, for example. Such a radius may be as large as the distance between the walls of container 10 and the container's center. The angle between the pyramidal roof and walls may be between 0.1 degrees and 85 degrees with a preferred range being from 10 to 60 degrees. In another example, the roof could have a conical shape with the walls rising toward the center of container 10 or any other shape having a center significantly higher than its edges. In another example, the center of the top of container 10 could be lower than its edges, i.e., the top of container 10 could be a concave roof. Such a configuration could deflect the liquid downward toward the center of container 10 to promote mixing of the contents of container 10. Also, the bottom of container 10 could have a flat reversed dome shape or a reversed flat pyramid shape to promote waves of liquid to climb up on the sides of container 10.

Also, container 10 may be formed of any rigid or semi-rigid material adapted to contain biopharmaceutical materials. For example, a semi-rigid material may retain its shape and/or stand up by itself when empty and when filled with a biopharmaceutical material. For example, such a semi-rigid container could be made of polyethylene or a multi-layered polymeric material. Further, container 10 may be coupled to various heating mechanisms to promote thawing of the biopharmaceutical material, examples of which are also described in the referenced patent application. Moreover, the various heating mechanisms and devices disclosed herein could also be cooling mechanisms for cooling the biopharmaceutical material held in container 10. For example, the biopharmaceutical material may be cooled during mixing of the biopharmaceutical materials in container 10. Further, the biopharmaceutical material could be cooled utilizing a thermal electric device attachment.

Further, although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims

In the claims:

1. A system for thawing, mixing or processing a biopharmaceutical material, said system comprising:
a movable platform; and
a container for holding the biopharmaceutical material, said container operatively mounted on said platform to allow said container to be skewed relative to said platform.

2. The system of claim 1 wherein said skewing comprises rotating said container relative to said platform.

3. The system of claim 1 wherein said platform is movable in a first direction and wherein said skewing comprises rotating said container about an axis substantially perpendicular to the first direction.

4. The system of claim 1 wherein said platform is movable in a first direction and said container is configured to rotate up to about 45 degrees relative to an indicator line substantially parallel to the first direction.

5. The system of claim 1 further comprising a base attached to said container wherein said base comprises a first side and a second side and said platform comprises a third side and a fourth side, wherein said first side is substantially aligned with said third side and said second side is substantial aligned with said fourth side in a first position and said base is configured to rotate up to about 45 degrees from said first position.

6. The system of claim 1 wherein said base is tiltable relative to said platform.

7. The system of claim 6 wherein said tilting comprises elevating a first end of said container relative to a second end of said container.

8. The system of claim 1 further comprising a temperature control element for controlling a temperature of the biopharmaceutical material in said container, said temperature control element operably coupled to said container.

9. The system of claim 1 further comprising a driving mechanism for causing movement of said platform.

10. The system of claim 1 further comprising an oscillatory driver configured to move said platform from a first position to a second position and to move said platform from said second position toward said first position, along a surface.

11. The system of claim 1 wherein said container comprises at least one of a cubical shape, a prismatic rectangular shape, a prismatic rhomboidal shape, a prismatic trapezoidal shape, a prismatic polygon shape, a cylindrical shape, a conical shape, a spherical shape, a pyramidal shape, a dome shape, a toroidal shape, and an elongated shape with a narrow waist portion.

12. A system for thawing, mixing, or processing a biopharmaceutical material, said system comprising:
a movable platform; and
a container for holding the biopharmaceutical material, said container operably mounted on said platform and said container tiltable relative to said platform.

13. The system of claim 12 wherein a first end of said container is tiltable relative to a second end of said container.

14. The system of claim 12 wherein said container is tiltable up to about 45 degrees relative to said platform.

15. The system of claim 12 wherein said platform is movable in a first direction and said tilting comprises rotating said base about an axis substantially perpendicular to said first direction.

16. The system of claim 12 wherein said container is skewable relative to said platform.

17. The system of claim 12 wherein said container is configured to be rotated about an axis substantially perpendicular to a bottom surface of said container.

18. The system of claim 12 wherein said platform is movable in a first direction and said skewing comprises rotating said container up to about 45 degrees relative to an indicator line substantially parallel to the first direction.

19. The system of claim 12 wherein a tilting of said container relative to said platform comprises a tilting angle which defines a right triangle having a hypotenuse, a first side and a second side, wherein said platform defines the first side and the second side is opposite said tilting angle, and wherein said skewing comprises rotating said container about an axis substantially perpendicular to the hypotenuse.

20. The system of claim 19 wherein the container is configured to rotate around said axis up to about 45 degrees.

21. The system of claim 12 further comprising a heating element for heating the biopharmaceutical material, said heating element being operably coupled to said container.

22. The system of claim 12 further comprising an oscillatory driver configured to move said platform from a first position to a second position and to move said platform from said second position toward said first position, along a surface.

23. The system of claim 12 further comprising a driving mechanism for causing movement of said platform.

24. A method for thawing, mixing, or processing biopharmaceutical materials, the method comprising:
moving a container holding the biopharmaceutical material in a first direction; and
skewing the container relative to the first direction.

25. The method of claim 24 wherein the skewing comprises rotating the container about an axis substantially perpendicular to the first direction.

26. The method of claim 25 wherein the skewing comprises rotating the container up to about 45 degrees relative to the first direction.

27. The method of claim 24 further comprising tilting a first end of the container relative to a second end of the container.

28. The method of claim 24 wherein the moving the container comprises moving the container from the first position to a second position along a surface and moving the container from the second position toward the first position along the surface.

29. The method of claim 24 further comprising controlling a temperature of the biopharmaceutical material.

30. A method for thawing, mixing, or processing a biopharmaceutical material, the method comprising:
moving a container holding the biopharmaceutical material; and
tilting a first end of the container relative to a second end of the container.

31. The method of claim 30 wherein the tilting comprises tilting the first end of the container up to about 45 degrees relative to the second end.

32. The method of claim 30 wherein the moving comprises moving the container in a first direction and further comprising skewing the container relative to the first direction.

33. The method of claim 32 wherein the moving comprises moving the container in a first direction and at least one of the skewing and the tilting comprises rotating the container about at least one axis substantially perpendicular to the first direction.

34. The method of claim 33 wherein the skewing comprises rotating the container up to about 45 degrees relative to an indicator line substantially parallel to the first direction.

35. The method of claim 30 wherein the tilting comprises a tilting angle which defines a right triangle having a hypotenuse, a first side and a second side, wherein the platform defines the first side and the second side is opposite the tilting angle, and further comprising rotating the container about an axis substantially perpendicular to the hypotenuse.

36. The method of claim 30 wherein the moving the container comprises moving the container from a first position to a second position along a surface and moving the container from the second position toward the first position along the surface.

37. A system for thawing, mixing, or processing a biopharmaceutical material, said system comprising:
a moveable platform;
a container for holding the biopharmaceutical material, said container moveably connected to said moveable platform; and
means for positioning said container relative to said moveable platform in three dimensions.

38. The system of claim 37 wherein said means for positioning comprising means for at least one of tilting and skewing said container relative to said platform.

39. The system of claim 1 wherein said skewing comprises forming a skewed shape of said container relative to said platform.

40. The system of claim 1 wherein said platform is movable in a first direction and wherein said skewing comprises forming a skewed shape of said container relative to an axis substantially perpendicular to the first direction.

41. The system of claim 1 wherein said platform is moveable in a first direction and said container is formed rotated about 45 degrees relative to an indicator line substantially parallel to the first direction.

42. The system of claim 12 wherein said operably mounting comprises said container being formed tilted relative to said platform.

43. A system for thawing, mixing or processing a biopharmaceutical material, said system comprising:
a movable container; and
wherein said container is skewable and tiltable relative to a direction of motion of said container.
